(19) United States
(12) Patent Application Publication
(10) Pub. No.: US 2003/0160110 A1
(43) Pub. Date: Aug. 28, 2003

(54) injection nozzle

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/936,215

(22) PCT Filed: Dec. 22, 2000
(86) PCT No.: PCT/DE00/04589

(30) Foreign Application Priority Data
Jan. 10, 2000 (DE) 100 00 575.6

(51) Int. Cl. F02M 41/16

(52) U.S. Cl. 239/96

(57) ABSTRACT

In a fuel injection nozzle for an internal combustion engine, having a nozzle body (10), a nozzle needle (12) which is displaceable in the nozzle body between a closed position, in which it rests on a sealing seat (16), and an opened position in which it is lifted from the sealing seat in the direction toward the combustion chamber, having a pressure chamber (24), which communicates with a fuel inlet (26), having a control chamber (42), which under the control of a control valve (46) communicates with the fuel inlet, and having a thrust rod (40), which communicates with the nozzle needle and protrudes into the control chamber, the object is to reliably furnish a closing force that overcomes an opening force generated in the region of the sealing seat. To that end, it is provided that the thrust rod is provided with a restoring piston (28), which closes off the pressure chamber (24) on the side remote from the sealing seat; that the outside diameter of the restoring piston is greater than the diameter of the sealing seat (16); and that the area resulting from the difference between the cross-sectional area of the restoring piston (28) and the area enclosed by the sealing seat (16) is less than the cross-sectional area of the thrust rod.

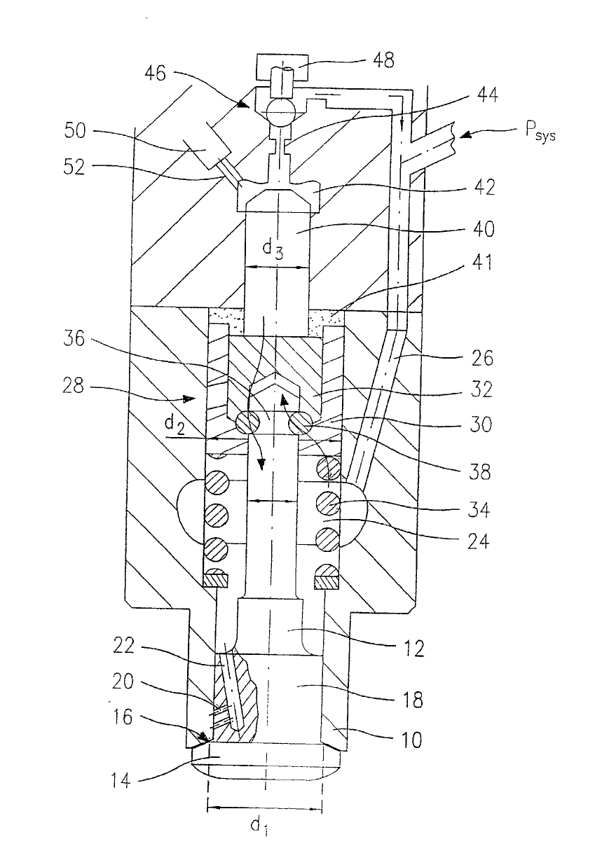

### PRIOR ART

The invention relates to a fuel injection nozzle for an internal combustion engine, having a nozzle body, a nozzle needle which is displaceable in the nozzle body between a closed position, in which it rests on a sealing seat, and an opened position in which it is lifted from the sealing seat in the direction toward the combustion chamber, having a pressure chamber, which communicates with a fuel inlet, having a control chamber, which under the control of a control valve communicates with the fuel inlet, and having a thrust rod, which communicates with the nozzle needle and protrudes into the control chamber.

An outward-opening injection nozzle of this kind is widely known. The opening and closing of the nozzle needle is attained by the control of the pressure in the control chamber. A problem in such an injection nozzle is that the diameter of the sealing seat is greater than the guide diameter of the nozzle needle in the front region, so that because of the differences in diameter, an opening force is generated. This can lead to an uncontrolled opening of the nozzle needle if the force is not compensated for. Another critical factor is that the opening force generated depends on the pressure in the pressure chamber and thus on the pressure in the fuel inlet.

### ADVANTAGES OF THE INVENTION

A fuel injection nozzle of the type defined at the outset, which has the characteristics of the body of claim 1, has the advantage that a greater closing force is obtained, because of the choice of the outside diameter of the restoring piston. This closing force is greater than the opening force operative in the region of the sealing seat, and thus reliable closure of the nozzle needle is assured as soon as the pressure in the control chamber drops, and thus an opening force is no longer transmitted via the thrust rod.

Preferably, a restoring spring is provided which is braced on the restoring piston. In the injection nozzle of the invention, the restoring piston serves solely to keep the nozzle needle, when the fuel injection system is turned off, in the closed state so that no fuel can enter the combustion chamber. In principle, the restoring spring represents an undesired variable in the design of the injection nozzle. While the opening and closing forces generated by the pressure in the fuel are proportional to the prevailing system, the restoring spring is a pressure-independent restoring force. This means that the forces generated by the spring, at low system pressure, make up a greater relative proportion of the prevailing total forces than when the system pressure is higher. Since in the injection nozzle of the invention the actual closing forces are furnished by the fuel pressure, the restoring spring can be dimensioned correspondingly weakly. Its relative proportion of the operative total forces thus drops.

Advantageous features of the invention will become apparent from the dependent claims.

### DRAWINGS

The invention is described below in of a preferred embodiment, which is shown in the appended sole drawing. This drawing figure shows a fuel injection nozzle of the invention in section.

### DESCRIPTION OF THE EXEMPLARY EMBODIMENT

The fuel injection nozzle of the invention serves to inject fuel into the combustion chamber (not shown) of an internal combustion engine. The fuel is furnished by a high-pressure system known as a “common rail”.

The injection nozzle has a nozzle body 10, in which a nozzle needle 12 is displaceably disposed. The nozzle needle 12, on its front end toward the combustion chamber, has a nozzle needle head 14, which cooperates with a sealing seat 16 on the nozzle body 10.

The head 14 of the nozzle needle 12 is adjoined by a guide portion 18 which is guided in the nozzle body 10 In the guide portion 18, there are a plurality of injection ports 20, which communicate with an injection conduit 22.

Beginning at the guide portion 18, the nozzle needle 12 extends through a pressure chamber 24 embodied in the nozzle body 10. The pressure chamber communicates with a fuel inlet 26, by way of which fuel that is under system pressure is delivered by the injection system.

The end of the pressure chamber 24 remote from the nozzle needle head 14 is closed by a restoring piston 28, which comprises an outer piston 30 and an inner piston 32. A restoring spring 34, which is disposed in the pressure chamber 24, is braced on the outer piston 30, and its other end is braced on a shoulder in the nozzle body 10.

The end of the nozzle needle 12 protruding into the restoring piston 28 is provided with a circumferential groove 36, in which a securing ring 38 is disposed. Both the outer piston 30 and the inner piston 32, each with a suitable shoulder, rest on this securing ring 38.

The inner piston 32 is provided, on the side remote from the nozzle needle head 14, with a thrust rod 40 that crosses through a leakage collection chamber 41 formed on the back side of the restoring piston 28, that is, the side remote from the nozzle needle head 14, and protrudes into a control chamber 42 formed in the nozzle body. The control chamber 42 communicates with the fuel inlet 26 via an inlet throttle 44 and a control valve 46. The control valve 46 includes a piezoelectric actuator 48, shown schematically, which can engender an opening and closure of the control valve. When the control valve is open, the control chamber 42 is supplied with fuel at system pressure. An outlet 50, which is provided with an outlet throttle 52, leads away from the control chamber 42.

The component parts of the injection nozzle that are relevant to the pressure forces acting on the nozzle needle 12 are dimensioned as follows: The outer piston 30 has an outside diameter d₂, which is greater than the diameter d₁ of the sealing seat 16 for the nozzle needle. The diameter d₃ of the thrust rod 40 is dimensioned such that the cross-sectional area of the thrust rod is greater than the area that results from the difference between the cross-sectional area of the restoring piston and the area enclosed by the sealing seat. Hence the following relationship must apply:

$$\frac{π {d}_{3}^{2}}{4} > \frac{π ( {d}_{3}^{2} - {d}_{1}^{2} )}{4} .$$

The fuel injection nozzle described functions as follows: If the fuel injection system is off, and thus no system pressure is being furnished, or if the system pressure is applied but the control valve 46 is closed, the nozzle needle 26 is in its closed position, shown in the drawing. When no system pressure is applied, this closure is assured by the restoring spring 34. If conversely the system pressure is applied, then a closing force is generated by the restoring piston 28, since the outer diameter d₂ of the restoring piston is greater than the diameter d₁ of the sealing seat 16. The resultant of the pressure forces that are exerted on the nozzle needle 12 by the fuel pressure prevailing in the pressure chamber 24 thus urges the nozzle needle into its closed position against the sealing seat 16.

If the control valve 46 is opened, the system pressure prevails in the control chamber 42, since the delivered fuel is prevented by the outlet throttle 52 from flowing directly out of the control chamber 42. Thus the system pressure acts on the cross-sectional area of the thrust rod 40 and generates an opening force. Since the cross-sectional area of the thrust rod 40 is greater than the area which results as the difference between the cross-sectional area of the outer piston 40 and the area enclosed by the sealing seat 16 and in the final analysis furnishes the closing force, the nozzle needle 12 executes an opening motion.

When the nozzle needle is to be closed again, first the control valve 46 is closed. Because of the outflowing fuel, the pressure in the control chamber 42 thereupon decreases, so that the opening force, which is generated in the pressure chamber 24 by the system pressure that continues to prevail closes the nozzle needle 12.

1. A fuel injection nozzle for an internal combustion engine, having a nozzle body (10), a nozzle needle (12) which is displaceable in the nozzle body between a closed position, in which it rests on a sealing seat (16), and an opened position in which it is lifted from the sealing seat in the direction toward the combustion chamber, having a pressure chamber (24), which communicates with a fuel inlet (26), having a control chamber (42), which under the control of a control valve (46) communicates with the fuel inlet, and having a thrust rod (40), which communicates with the nozzle needle and protrudes into the control chamber, characterized in that the thrust rod is provided with a restoring piston (28), which closes off the pressure chamber (24) on the side remote from the sealing seat; that the outside diameter of the restoring piston is greater than the diameter of the sealing seat (16); and that the area resulting from the difference between the cross-sectional area of the restoring piston (28) and the area enclosed by the sealing seat (16) is less than the cross-sectional area of the thrust rod.

2. The injection nozzle of claim 1, characterized in that the restoring piston (28) comprises an inner piston (32) and an outer piston (30), and that a securing ring (38) which is engaged by the inner piston and the outer piston is mounted on the nozzle needle.

3. The injection nozzle of one of claims 1 and 2, characterized in that a restoring spring (34), which is braced on the restoring piston, is disposed in the pressure chamber (24).

4. The injection nozzle of one of the foregoing claims, characterized in that the control valve (46) includes a piezoelectric actuator (48).
